(19) United States
(12) Patent Application Publication
(10) Pub. No.: US 2007/0284341 A1
(43) Pub. Date: Dec. 13, 2007

(54) Method of Laser Welding Without Filler Material, and an Electrical Device Suitable for Being Made by the Method

(75) Inventors: Jean-Claude Gasquet, Saint-Clement (FR); Jean-Michel Morelle, Beaugency (FR); Alcina Tanghe, Melun (FR); Laurent Vivet, Bois d'Arcy (FR); Bertrand Torcheux, Thiverval Graignon (FR)

Correspondence Address: OLIFF & BERRIDGE, PLC, P.O. BOX 19928, ALEXANDRIA, VA, 22320, US

(73) Assignee: VALEO ELECTRONIQUE ET SYSTEMES DE LIAISON, Montigny-le-Bretonneux (FR)

(21) Appl. No.: 11/667,457

(22) PCT Filed: Nov. 14, 2005
(86) PCT No.: PCT/FR05/02818

§ 371 Date: Jun. 25, 2007

(30) Foreign Application Priority Data
Nov. 15, 2004 (FR) 0412079

(51) Int. Cl. B23K 15/06; B23K 26/20; H01R 4/00

(52) U.S. Cl. 219/121.14; 174/84 R; 219/121.64

(57) ABSTRACT

The welding method is for connecting together first and second metal elements (20, 16). The first element (20) forms a support or is for being fitted onto a support (12). During the method, a welding portion (20A) is formed in the first element (20), the welding portion having a connection end (22) connected to a support portion (20B) of the first element (20). A free end face (F) is formed in the welding portion (20A) of the first element (20) remote from the connection end (22). A high-energy beam (24) is directed onto the welding portion (20A) of the first element (20) in such a manner that the axis (X) of the beam (24) passes through the welding portion (20A) from the free end face (F) towards the connection end (22), thereby causing at least a portion of the mass of said first element (20) to melt, the molten mass coming into contact with the second element (16) by said mass collapsing.

The present invention relates to a method of welding without filler material and to an electrical device suitable for being made by the method.

The invention applies in particular to connecting an electrical component provided with at least one electrical connection pin to a substrate.

From the state of the art, and in particular from EP-A-1 400 303, a method is already known for welding without filler material to connect together first and second metal elements, the first element forming a support or being for fitting to a support, and the method being of the type comprising:
forming a welding portion in the first element, the welding portion being provided with a connection end connecting it with a support portion of the first element; and
directing a high-energy beam onto the welding portion of the first element so as to cause at least a portion of the mass of the first element to melt, the molten mass coming into contact with the second element by said mass collapsing.

In document EP-A-1 400 303, the first element is formed by a plate and the second element is formed by a rod. The plate is lanced so as to define projecting tongues. Each tongue forming a welding portion is connected by a bend to the remainder of the plate that forms a support portion. Each tongue is generally triangular in shape, being defined by the bend and by two adjacent free edges.

The rod is for engaging in the lanced hole so as to ensure precise contact with the tongues, while folding the tongues perpendicularly to the plate. Once the rod has been engaged, each tongue has an inside surface in contact with the rod and an outside surface that is opposite to its inside surface.

Document EP-A-1 400 303 proposes causing each tongue to melt by means of a high-energy beam of the laser type. For this purpose, the axis of the laser beam is directed towards the outside surfaces of the tongues.

Given the inaccuracies with which the focusing point of the laser beam is positioned, a greater or smaller fraction of the energy of the beam is liable to be transmitted to the rod.

The welding method described in the above document does not appear to be adapted to connecting together a pin (forming a flexible rod) for electrically connecting an electrical component with a metal substrate (forming a plate).

The flexible pin of the electrical component is not sufficiently rigid to fold the tongues formed by lancing the substrate. It is therefore not possible to obtain precise contact between the tongues and the pin of the electrical component merely by engaging the (flexible) pin of the electrical component in the lanced hole through the substrate, as proposed in EP-A-1 400 303.

Furthermore, the inaccuracies in positioning the focusing point of the laser beam are liable to cause an excessive amount of energy to be transmitted to the pin of the electrical component, thereby destroying the pin.

A particular object of the invention is to connect the pins of an electrical component electrically and mechanically to a metal substrate by using a welding method without filler material of the type specified above.

To this end, the invention provides a method of the above-specified type for welding without filler material for the purpose of welding together first and second metal elements, the method being characterized by:
forming a free end face in the welding portion of the first element remote from its connection end; and
directing the high-energy beam onto the welding portion in such a manner that the axis of the beam passes through the welding portion from the free end face towards the connection end.

By the particular orientation of the high-energy beam that is proposed by the invention, the second element, e.g. forming an electrical component pin, does not receive an excessive quantity of energy coming from the beam. The main fraction of the energy of the beam is absorbed by the welding portion of the first element.

Furthermore, the relative positioning between the first and second elements can be relatively coarse, since the collapse of the molten mass of the first element makes it possible, where necessary, to fill in the gap between the first and second elements.

Finally, the inaccuracy in the positioning of the focusing point of the high-energy beam does not lead to undesirable exposure of the second element to the beam. In spite of these inaccuracies, the focusing point remains situated in the mass of the welding portion of the first element, between its free end face and its connection end.

According to other characteristics of the welding method, that are optional:
the welding portion is connected to the support portion by a fold forming the connection end of said welding portion, the free end face being substantially parallel to the fold;
the angle between the axis of the high-energy beam and the free end face is substantially equal to 90°;
the angle between the axis of the high-energy beam and the free end face is greater than 90°, so as to reflect a portion of the beam towards the second element;
the high-energy beam is a laser beam;
the laser beam is emitted by a pulse source, the duration of the pulses preferably lying in the range 2 milliseconds (ms) to 20 ms;
the high-energy beam is an electron beam emitted in a vacuum;
the support portion of the first element is fitted onto a substrate, preferably prior to connecting the first element to the second element;
the substrate includes a metal coating, and the support portion of the first element is fitted to the substrate by being soldered onto the metal coating of the substrate;
the support portion of the first element is generally in the form of a bridge having two opposite ends that are fitted onto the substrate;
the welding portion is formed by lancing the support portion between the two ends of said support portion;
the first element forms a tab made from the material of a support carrying at least the second element;
the second element is in the form of an electrical connection pin of an electrical component, e.g. a component of the through type;
the free end face is generally rectangular in shape, being defined by two opposite edges, respectively an edge that is close to the second element and an edge that is far therefrom, the distance between the two edges lying in the range 0.2 millimeters (mm) to 1 mm; and
the opposite, near and far edges are substantially parallel to the fold.

The invention also provides an electrical device of the type comprising a substrate forming an electrical conductor, and an electrical component provided with at least one pin for electrically connecting to the substrate, the device being characterized in that it includes an element provided with a first portion welded to the pin and a second portion fitted onto the substrate, e.g. by soldering.

The invention can be better understood on reading the following description given purely by way of example and made with reference to the accompanying drawings, in which:

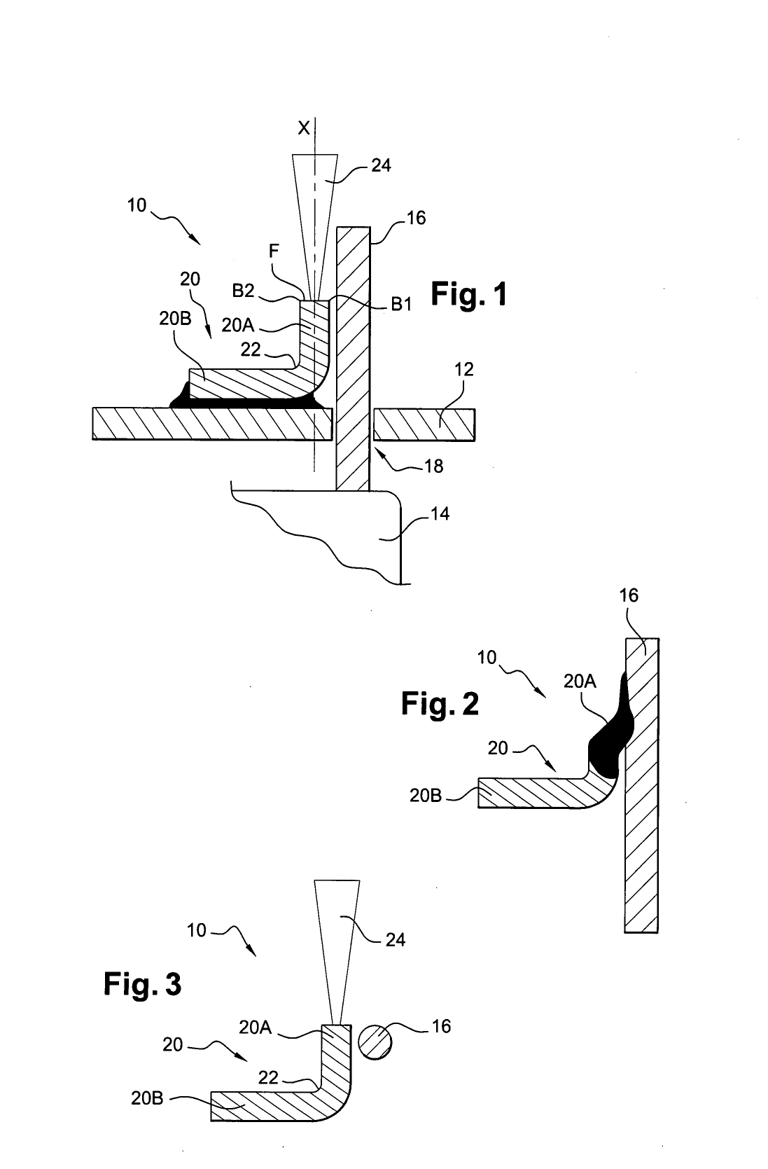

FIG. 1 is an axial section view of an electrical device in a first embodiment of the invention shown during manufacture, prior to the weld being formed for connecting together the first and second metal elements;

FIG. 2 is a view similar to FIG. 1, showing the weld connecting together the first and second metal elements;

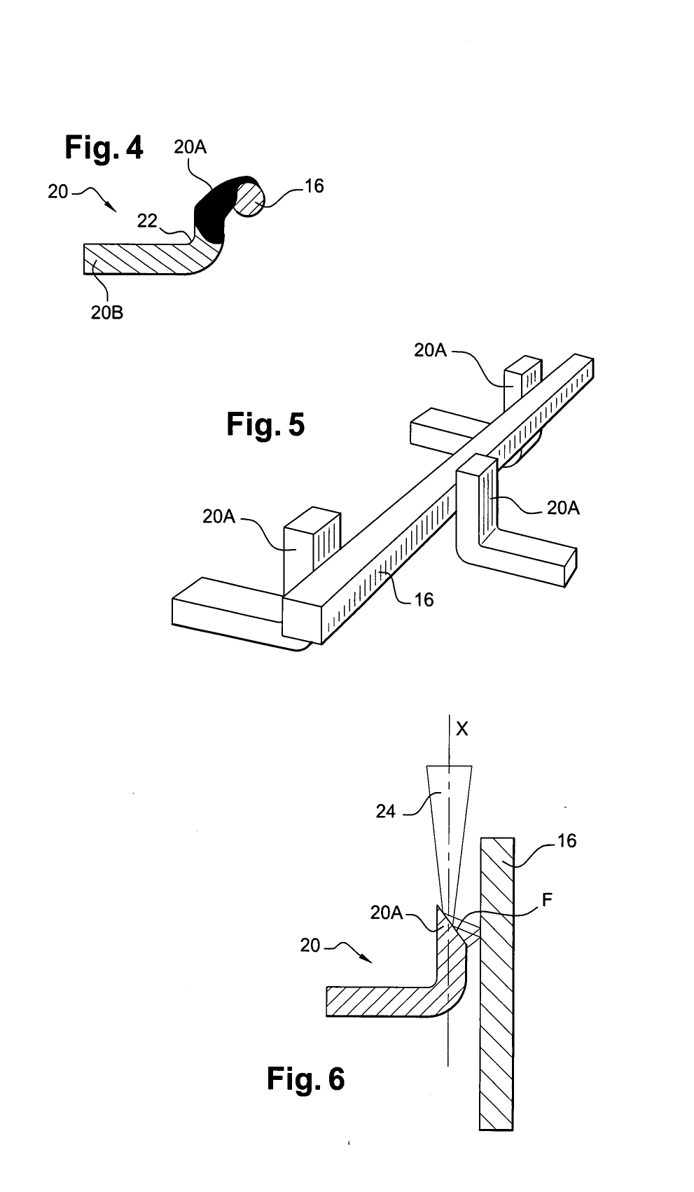

FIGS. 3 and 4 are views similar to FIGS. 1 and 2 showing an electrical device in a second embodiment of the invention;

FIG. 5 is a perspective view of an electrical device in a third embodiment of the invention shown during fabrication, before the weld is formed connecting together the first and second metal elements;

FIG. 6 is a view similar to FIG. 1 showing an electrical device in a fourth embodiment of the invention;

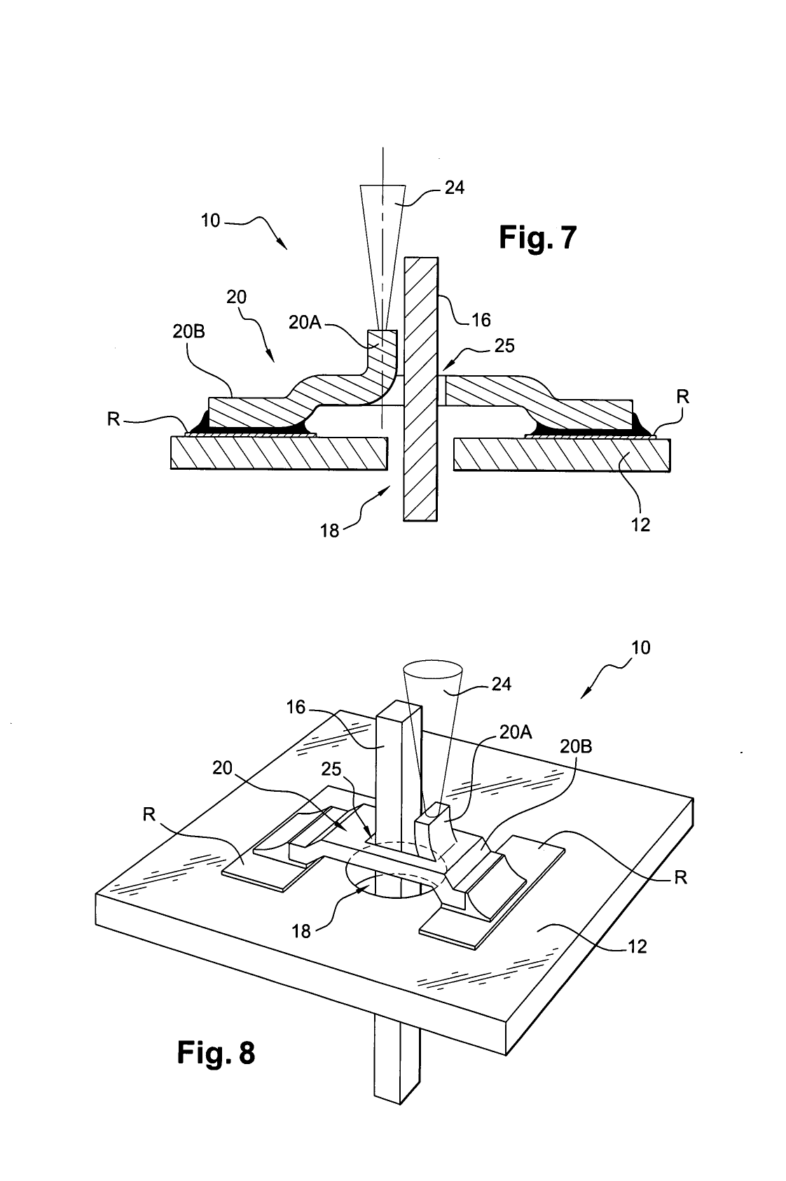

FIGS. 7 and 8 are respectively an axial section view and a perspective view showing an electrical device in a fifth embodiment of the invention;

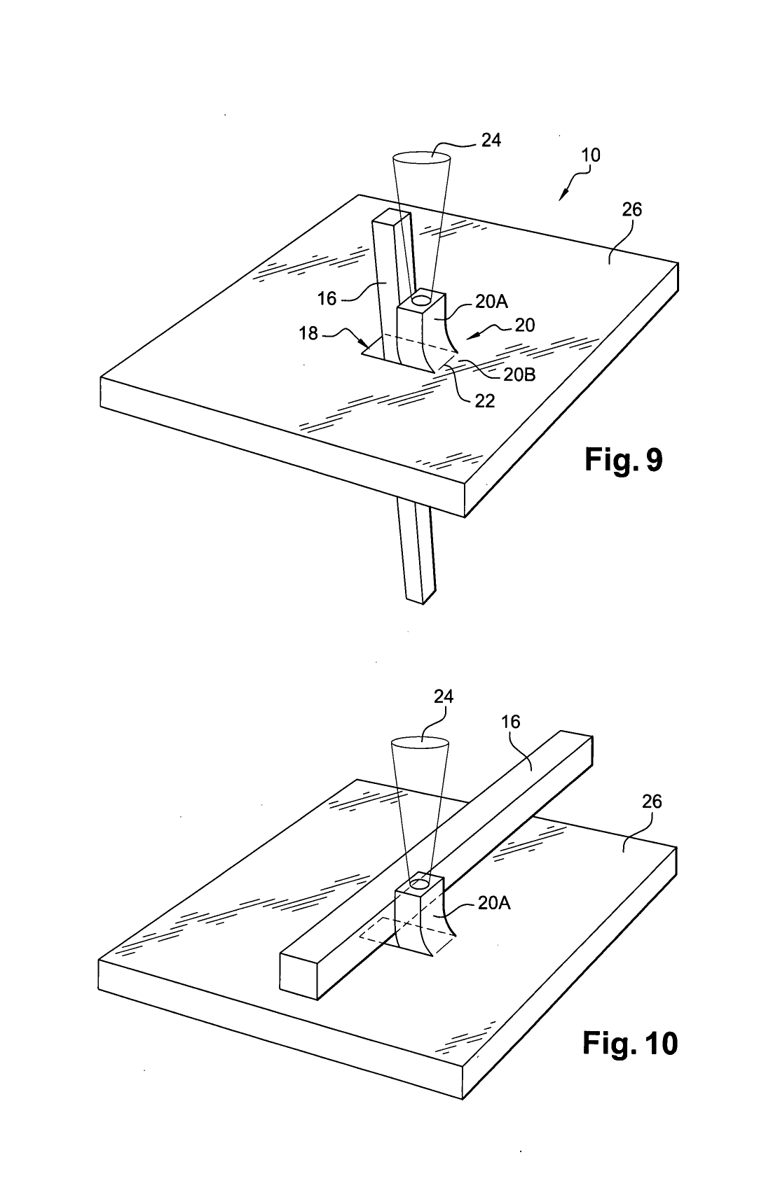

FIG. 9 is a perspective view of an electrical device in a sixth embodiment of the invention, shown during fabrication, before the weld is formed connecting together the first and second metal elements; and

FIGS. 10 to 13 are views similar to FIG. 9, showing electrical devices constituting respectively seventh, eighth, ninth, and tenth embodiments of the invention.

FIG. 1 shows an electrical device constituting a first embodiment of the invention and given overall reference 10.

The device 10 comprises a substrate 12 provided with a conventional metal coating (not shown) forming an electrical conductor.

The electrical device 10 also comprises an electrical component 14 provided with at least one metal pin 16 for connecting electrically to the substrate 12.

In the example described, the electrical component 14 is of the through type. The pin 16 extends through a hole 18 in the substrate 12.

The electrical component 14 is electrically and mechanically connected to the substrate 12 by means of a metal element 20 provided with a first portion 20A for welding to the pin 16, and a second portion 20B that is fitted onto the metal coating of the substrate 12, e.g. by soldering. By way of example, the element 20 is formed by bending a metal rod of rectangular section.

In the example shown, the welding portion 20A is at an angle of about 90° with the support portion 20B.

The welding portion 20A is connected to the support portion 20B by a bend 22 forming a connection end between the welding portion 20A and the support portion 20B.

Before or after the element 20 is bent, a free end face F is formed in the welding portion 20A of the element 20 remote from the bend 22 forming the connection end of the welding portion 20A.

In the example described, the free end face F is generally rectangular in shape, being defined by two opposite edges, respectively an edge B1 near to the pin 16 and an edge B2 remote therefrom. It should be observed that the two ends B1 and B2 are substantially parallel to the bend 22.

The distance between the two edges B1 and B2 preferably lies in the range 0.2 mm to 1 mm.

In the device 10 constituting the first embodiment of the embodiment, the pin 16 and the welding portion 20A of the element 20 extend substantially parallel to each other.

To weld the welding portion 20A of the element 20 to the pin 16, the procedure is as follows.

After the element 20 has been shaped as shown in FIG. 1 and as described above, the support portion 20B of the element 20 is fitted by soldering onto the metal coating of the substrate 12.

Thereafter, the pin 16 is positioned through the hole 18 so that said pin 16 extends close to or in contact with the welding portion 20A of the element 20.

The welding portion 20A of the element 20 is then welded to the pin 16 without using any filler material, by means of a high-energy beam 24, preferably a laser beam. In a variant, the high-energy beam could be an electron beam emitted in a vacuum.

As shown in FIG. 1, the high-energy beam 24 is directed onto the welding portion 20A of the element 20 in such a manner that the axis X of the beam 24 passes through the welding portion 20A from its free end face F towards the bend 22 forming its connection end.

The energy transmitted to the welding portion 20A by the beam 24 at least part of the mass of this welding portion 20A to melt.

The pin 16 and the element 20 are placed relative to each other in such a manner that the molten mass comes into contact with the pin 16 by virtue of said mass collapsing (see FIG. 2).

The laser beam 24 is preferably emitted by a pulse source with pulses having a duration lying in the range 2 ms to 20 ms.

The height of the welding portion 20A of the element 20 (i.e. the dimension between the free end face F and the bend 22) can be determined by successive tests so as to obtain a satisfactory penetration depth into the element 20 of the energy from the beam and an appropriate volume of molten mass of the element 20.

The melting temperature of the welding portion 20A is preferably higher than that of the pin 16 so as to enable the surface of the pin 16 to melt appropriately on coming into contact with the molten mass of the welding portion 20A of the element 20.

In the device 10 in the first embodiment of the invention, the angle between the axis X of the beam 24 and the free end face F is substantially equal to 90°. A fraction of the radiation of the beam 24 is thus reflected towards the source of the beam 24 and is processed by means that are themselves known.

In a variant, the support portion 20B of the element 20 could be soldered onto the metal coating of the substrate 12 after the welding portion 20A of the element 20 has been welded to the pin 16.

FIGS. 3 to 13 show electrical devices 10 constituting second through tenth embodiments of the invention. In these figures, elements that are analogous to those of the preceding figures, are designated by references that are identical.

In the second embodiment of the invention, shown in FIGS. 3 and 4, the pin 16 and the welding portion 20A are substantially orthogonal.

The electrical device 10 of the third embodiment of the invention as shown in FIG. 5 differs from the preceding embodiments in that it has a plurality of elements 20A for connection to the pin 16 using the above-described means and method.

In the fourth embodiment shown in FIG. 6, the welding portion 20A of the element 20 is chamfered so that the angle between the axis X of the beam 24 and the free end face F is greater than 90°. A portion of the beam 24 is thus reflected in diffuse manner towards the pin 16. Under such circumstances, multiple reflections become established between the pin 16 and the welding portion 20A of the element 20, thus enabling the surface of the pin 16 to be heated without being heated excessively. Heating the surface of the pin 16 optimizes the wettability of said surface and optimizes contact between the molten mass of the element 20 and the pin 16.

The electrical device 10 of the fifth embodiment of the invention shown in FIGS. 7 and 8 differs from the electrical devices shown in the preceding figures in that the metal element 20 is obtained by folding and puncturing a plate.

The support portion 20B of the metal element 20 is generally in the form of a bridge having two opposite ends forming tabs, each of which is fitted onto a portion R of the metal coating on the substrate 12 by soldering.

A lancing formed in the portion 20B (between the two soldered ends thereof) serves firstly to form a tab corresponding to the welding portion 20A, and secondly a hole 25 in the element 20. The pin 16 extends through the hole 18 in the substrate 12 and also through the hole 25 in the element 20.

Advantageously, the metal element 20 may be fitted onto the substrate 12 using conventional surface-mounting methods and at the same time as other surface-mount components are mounted.

It should be observed that the bridge shape of the support portion 20B enables the metal element 20 to be positioned in stable manner on the substrate 12 before and during soldering to the metal coating.

It should also be observed that the hole 18 of the substrate 12 may be of relatively large size, the position of the hole 18 in the substrate 12 possibly being relatively imprecise without that harming the precision with which the pin 16 is positioned relative to the welding portion 20A.

In the fifth through ninth embodiments of the invention, shown in FIGS. 9 to 13, instead of being fitted on a substrate 12 as in the embodiments described above, the element 20 forms a tab made out of the same material as a support 26, which support carries at least one pin 16. By way of example, the support 26 may be a conductive copper plate.

Thus, in the sixth embodiment, shown in FIG. 9, the hole 18 and the tab 20 are formed by lancing the support 26. The pin 16 extends through the hole 18.

The electrical device 10 of the seventh embodiment of the invention shown in FIG. 10 differs from the preceding device in that the pin 16 and the welding portion 20A are substantially orthogonal.

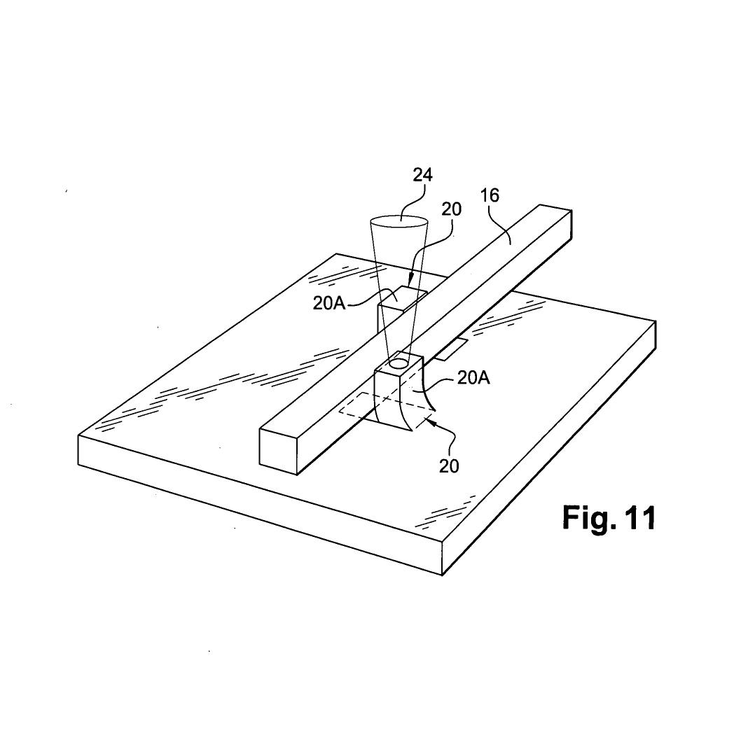

The electrical device 10 of the eighth embodiment of the invention, as shown in FIG. 11, differs from the preceding device in that it has two elements 20 for connection to the pin 16. The two elements 20 are mutually offset transversely on either side of the pin 16 and longitudinally along the pin 16.

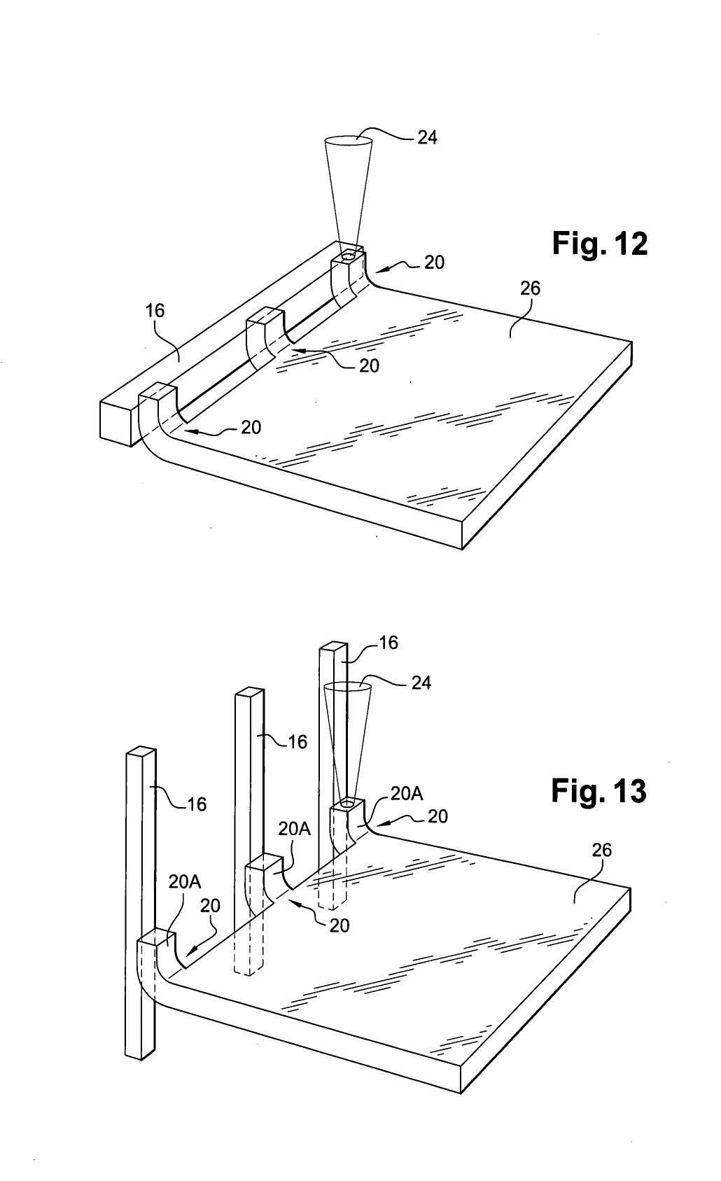

In the ninth embodiment, shown in FIG. 12, the device 10 comprises a plurality of elements 20 for connection to the pin 16, extending orthogonally to said element 20. Unlike the three preceding embodiments, the elements 20 are obtained by shaping, e.g. cutting and folding, an edge of the support 26, in such a manner as to connect the pin 16 to the edge of the support 26.

The electrical device 10 of the tenth embodiment of the invention, shown in FIG. 13, differs from the preceding embodiment in that each welding portion 20A is for connection to a corresponding pin 16, extending substantially parallel to said welding portion 20A.

The invention is not restricted to the embodiments described above.

In particular, the welding portion 20A of the element 20 may present a dimension parallel to the bend 22 that is relatively large, so that a plurality of pins can be connected to the welding portion 20A, each by a corresponding weld.

Amongst the advantages of the invention, it should be observed that welding without filler material as implemented in accordance with the method of the invention makes it possible to connect together first and second metal elements electrically, mechanically, and/or thermally.

Furthermore, the welding portion 20A of the element 20 and the pin 16 may be mutually parallel or mutually orthogonal.

1. A method of welding without filler material for connecting together first and second metal elements, the first element forming a support or being for fitting to a support, the method comprising:
forming a welding portion in the first element, the welding portion being provided with a connection end connecting it with a support portion of the first element; and
directing a high-energy beam onto the welding portion of the first element so as to cause at least a portion of the mass of the first element to melt, the molten mass coming into contact with the second element by said mass collapsing;
wherein the method further comprises:
forming a free end face in the welding portion of the first element remote from its connection end; and
directing the high-energy beam onto the welding portion in such a manner that the axis of the beams passes through the welding portion from the free end face towards the connection end.

2. A method according to claim 1, in which the welding portion is connected to the support portion by a fold forming the connection end of said welding portion, the free end face being substantially parallel to the fold.

3. A method according to claim 1, in which the angle between the axis of the high-energy beam and the free end face is substantially equal to 90°.

4. A method according to claim 1, in which the angle between the axis of the high-energy beam and the free end face is greater than 90°, so as to reflect a portion of the beam towards the second element.

5. A method according to claim 1, in which the high-energy beam is a laser beam.

6. A method according to claim 5, in which the laser beam is emitted by a pulse source, the duration of the pulses preferably lying in the range 2 ms to 20 ms.

7. A method according to claim 1, in which the high-energy beam is an electron beam emitted in a vacuum.

8. A method according to claim 1, in which the support portion of the first element is fitted onto a substrate, preferably prior to connecting the first element to the second element.

9. A method according to claim 8, in which the substrate includes a metal coating, and the support portion of the first element is fitted to the substrate by being soldered onto the metal coating of the substrate.

10. A method according to claim 8, in which the support portion of the first element is generally in the form of a bridge having two opposite ends that are fitted onto the substrate.

11. A method according to claim 10, in which the welding portion is formed by lancing the support portion between the two ends of said support portion.

12. A method according to claim 1, in which the first element forms a tab made from the material of a support carrying at least the second element.

13. A method according to claim 1, in which the second element is in the form of an electrical connection pin of an electrical component, e.g. a component of the through type.

14. A method according to claim 1, in which the free end face is generally rectangular in shape, being defined by two opposite edges, respectively an edge that is close to the second element and an edge that is far therefrom, the distance between the two edges lying in the range 0.2 mm to 1 mm.

15. A method according to claim 2, in which the free end face is generally rectangular in shape, being defined by two opposite edges, respectively an edge that is close to the second element and an edge that is far therefrom, the distance between the two edges lying in the range 0.2 mm to 1 mm, and the opposite, near and far edges are substantially parallel to the fold.

16. An electrical device comprising a substrates forming an electrical conductor, and an electrical component provided with at least one pin for electrically connecting to the substrate, the device including an element provided with a first portion welded to the pin and a second portion fitted onto the substrates, e.g. by soldering.
